(19) United States
(12) Patent Application Publication
(10) Pub. No.: US 2024/0323042 A1
(43) Pub. Date: Sep. 26, 2024

(54) IMAGE PROCESSING SYSTEM AND IMAGE PROCESSING METHOD FOR VIDEO CONFERENCING SOFTWARE

(71) Applicant: ASPEED Technology Inc., Hsinchu City (TW)

(72) Inventor: Chen-Wei Chou, Hsinchu City (TW)

(73) Assignee: ASPEED Technology Inc., Hsinchu City (TW)

(21) Appl. No.: 18/342,720

(22) Filed: Jun. 27, 2023

(30) Foreign Application Priority Data
Mar. 24, 2023 (TW) 112111031

(51) Int. Cl. H04L 12/18; G06T 7/11

(52) U.S. Cl. CPC H04L 12/1831; G06T 7/11; G06T 2207/20132

(57) ABSTRACT

An image processing system and an image processing method for a video conferencing software are provided. The image processing method includes: capturing a first original image by a first image capture device and capturing a second original image by a second image capture device; generating first information corresponding to the first original image and transmitting the first information to the first image capture device; cropping a first cropped image from the first original image according to a first mapping relationship in the first information by the first image capture device; and outputting an output image including the first cropped image and a second cropped image corresponding to the second original image to the video conferencing software according to a second mapping relationship in the first information by the first image capture device.

### CROSS-REFERENCE TO RELATED APPLICATION

This application claims the priority benefit of Taiwan application serial no. 112111031, filed on Mar. 24, 2023. The entirety of the above-mentioned patent application is hereby incorporated by reference herein and made a part of this specification.

### BACKGROUND

### Technical Field

The disclosure relates to an image processing technology, and in particular relates to an image processing system and an image processing method for a video conferencing software.

### Description of Related Art

Conventional video conferencing software may obtain audio and image from a single webcam, and configure the obtained image in a specific display region of the layout of the output image. However, this approach limits the layout of the output image. For example, conventional video conferencing software may only assign a single region of interest (ROI) to a single image. Even if the image is a panoramic image including multiple people, the video conferencing software may only capture the image of a single person from the panoramic image according to a single region of interest.

Accordingly, how to flexibly configure the layout of output images according to the images captured by one or more webcams is one of the important issues in this field.

### SUMMARY

An image processing system and an image processing method for a video conferencing software, which may flexibly configure the layout of output images of the video conferencing software, are provided in the disclosure.

An image processing system for a video conferencing software of the disclosure includes a first image capture device, a second image capture device, and a computing device. The first image capture device captures a first original image. The second image capture device captures a second original image. The computing device is communicatively connected to the first image capture device and the second image capture device, and generates first information corresponding to the first original image, in which the first image capture device obtains the first information. A first cropped image is cropped from a first original image according to the first mapping relationship in the first information, in which the first image capture device outputs an output image including the first cropped image and a second cropped image corresponding to the second original image to the video conferencing software according to a second mapping relationship in the first information.

In an embodiment of the disclosure, the first image capture device generates a first down-sampled image according to the first original image, and transmits the first down-sampled image to the computing device. The computing device generates the first information according to the first down-sampled image, in which resolution of the first down-sampled image is less than resolution of the first original image.

In an embodiment of the disclosure, the computing device generates second information corresponding to the second original image, and transmits the second information to the second image capture device. The second image capture device crops the second cropped image from the second original image according to a third mapping relationship in the second information.

In an embodiment of the disclosure, the second image capture device generates a second down-sampled image according to the second original image, and transmits the second down-sampled image to the computing device. The computing device generates the second information according to the second down-sampled image, in which resolution of the second down-sampled image is less than resolution of the second original image.

In an embodiment of the disclosure, the second image capture device is communicatively connected to the first image capture device, and transmits the second cropped image to the first image capture device.

In an embodiment of the disclosure, the second image capture device transmits the second cropped image to the first image capture device through the computing device.

In an embodiment of the disclosure, the computing device obtains the second original image from the second image capture device, generates the second cropped image according to the second original image, and transmits the second cropped image to the first image capture device.

In an embodiment of the disclosure, the second mapping relationship includes a mapping relationship between the first cropped image and the output image and a mapping relationship between the second cropped image and the output image.

In an embodiment of the disclosure, the computing device executes object detection on the first down-sampled image to generate a first object detection result, and generates the first information according to the first object detection result.

In an embodiment of the disclosure, the first object detection result includes multiple bounding boxes, and the image processing system further includes an audio capture device. The audio capture device is communicatively connected to the computing device, in which in response to obtaining the audio from the audio capture device, the computing device selects a first bounding box corresponding to the audio from the bounding boxes, and generates the first information according to the first bounding box.

In an embodiment of the disclosure, the computing device obtains the first object detection result corresponding to the first image capture device and a second object detection result corresponding to the second image capture device, wherein the first object detection result includes a first bounding box corresponding to an object, and the second object detection result includes a second bounding box corresponding to the object. In response to a size of the first bounding box being greater than a size of the second bounding box, the computing device selects the first bounding box from the first bounding box and the second bounding box, so as to generate the first information according to the first bounding box.

In an embodiment of the disclosure, the computing device obtains the first object detection result corresponding to the first image capture device and a second object detection result corresponding to the second image capture device, wherein the first object detection result includes a first bounding box corresponding to an object, and the second object detection result includes a second bounding box corresponding to the object. The computing device determines a first angle between a facing direction of the object and the first image capture device according to the first bounding box, and determines a second angle between the facing direction of the object and the second image capture device according to the second bounding box. In response to the first angle being less than the second angle, the computing device selects the first bounding box from the first bounding box and the second bounding box, so as to generate the first information according to the first bounding box.

In an embodiment of the disclosure, the computing device receives a user instruction, and generates the first mapping relationship according to the user instruction.

In an embodiment of the disclosure, the first object detection result includes multiple bounding boxes, in which the computing device receives a user instruction, and selects a first bounding box from the bounding boxes according to the user instruction, so as to generate the first mapping relationship according to the first bounding box.

In an embodiment of the disclosure, the first object detection result includes multiple bounding boxes, in which the computing device generates the first mapping relationship according to a number of the bounding boxes.

In an embodiment of the disclosure, the first mapping relationship includes a first size and a first coordinate corresponding to the first original image, in which the second mapping relationship includes a second size and a second coordinate corresponding to the output image.

In an embodiment of the disclosure, the first mapping relationship includes a first size corresponding to the first down-sampled image, in which the first image capture device updates the first size according to a resolution of the first original image and a resolution of the first down-sampled image.

An image processing method for a video conferencing software of the disclosure, including the following operation. A first original image is captured by a first image capture device and a second original image is captured by a second image capture device. First information is generated corresponding to the first original image and the first information is transmitted to the first image capture device. A first cropped image is cropped from the first original image according to a first mapping relationship in the first information by the first image capture device. An output image including the first cropped image and a second cropped image corresponding to the second original image are output to the video conferencing software according to a second mapping relationship in the first information by the first image capture device.

Based on the above, the image processing system of the disclosure provides a flexible layout configuration method for the output image of the video conferencing software, and may dynamically change the region of interest of the image so that the video conferencing software may instantly display the most important person in the current video conference.

### BRIEF DESCRIPTION OF THE DRAWINGS

FIG. 1 is a schematic diagram of an image processing system for a video conferencing software according to an embodiment of the disclosure.

FIG. 2 is a schematic diagram of an original image according to an embodiment of the disclosure.

FIG. 3 is a schematic diagram of an original image provided by a single image capture device according to an embodiment of the disclosure.

FIG. 4 is a schematic diagram of information provided by a single image capture device according to an embodiment of the disclosure.

FIG. 5 is a schematic diagram of an original image provided by multiple image capture devices according to an embodiment of the disclosure.

FIG. 6 is a schematic diagram of information provided by multiple image capture devices according to an embodiment of the disclosure.

FIG. 7A is a schematic diagram of a cropped image generated by an image capture device according to an embodiment of the disclosure.

FIG. 7B is a schematic diagram of a cropped image generated by a computing device according to an embodiment of the disclosure.

FIG. 8 is a flowchart of an image processing method for a video conferencing software according to an embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

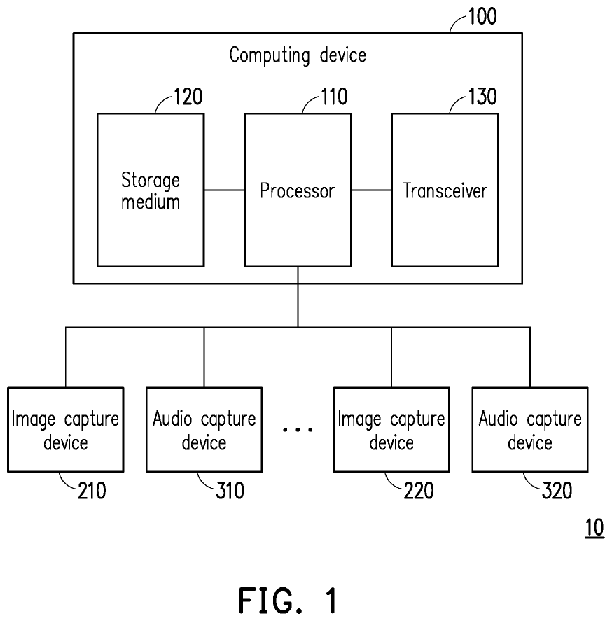

FIG. 1 is a schematic diagram of an image processing system 10 for a video conferencing software according to an embodiment of the disclosure, in which the image processing system 10 may transmit output images to the video conferencing software. The video conferencing software may display output images for users to conduct video conferences. The image processing system 10 may include a computing device 100 and one or more image capture devices, in which the number of the one or more image capture devices may be any positive integer. In this embodiment, the one or more image capture devices may include an image capture device 210 and an image capture device 220. One or more elements in the image processing system 10 (e.g., the computing device 100) may be embedded in a computer for running video conferencing software.

In an embodiment, the image processing system 10 may further include one or more audio capture devices, in which the number of the one or more audio capture devices may be any positive integer. The image capture devices may respectively have a corresponding dedicated audio capture device, or the image capture devices may share the same audio capture device. In one embodiment, the one or more audio capture devices include an audio capture device 310 corresponding to the image capture device 210 and an audio capture device 320 corresponding to the image capture device 220. When generating the output image for the video conferencing software, the computing device 100 may match the audio obtained by the audio capture device with the image obtained by the image capture device, so that the displayed content of the output image is synchronized with the audio.

The computing device 100 may include a processor 110, a storage medium 120, and a transceiver 130. The computing device 100 may be communicatively connected to the image capture device 210, the image capture device 220, the audio capture device 310, and the audio capture device 320 through the transceiver 130.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. The processor 110 may be coupled to the storage medium 120 and the transceiver 130, and access and execute multiple modules and various application programs stored in the storage medium 120.

The storage medium 120 is, for example, any type of fixed or removable random access memory (RAM), read-only memory (ROM), flash memory, hard disk drive (HDD), solid state drive (SSD), or similar elements, or a combination of the elements thereof configured to store multiple modules or various applications executable by the processor 110.

The transceiver 130 transmits and receives signals in a wireless or wired manner. The transceiver 130 may also perform operations such as low noise amplification, impedance matching, frequency mixing, up or down frequency conversion, filtering, amplification, and the like.

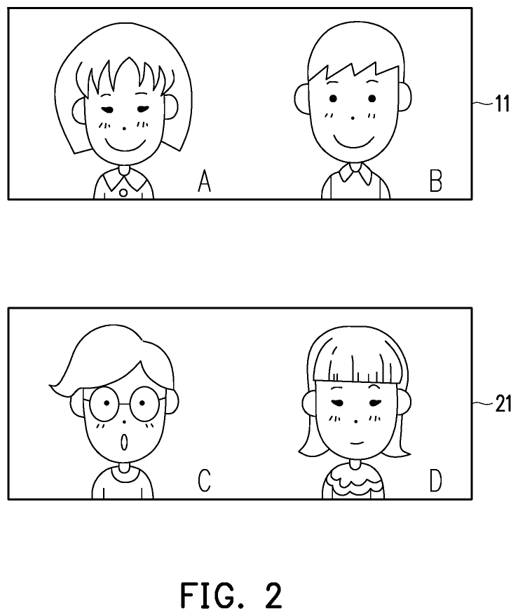

The image capture device 210 or the image capture device 220 is configured to capture the original image. FIG. 2 is a schematic diagram of an original image according to an embodiment of the disclosure. The original image 11 is an original image captured by the image capture device 210, and the original image 21 is an original image captured by the image capture device 220. In this embodiment, the original image 11 includes a person A and a person B, and the original image 21 includes a person C and a person D. The audio capture device 310 or the audio capture device 320 is, for example, a condenser microphone, a dynamic microphone, or an electret microphone.

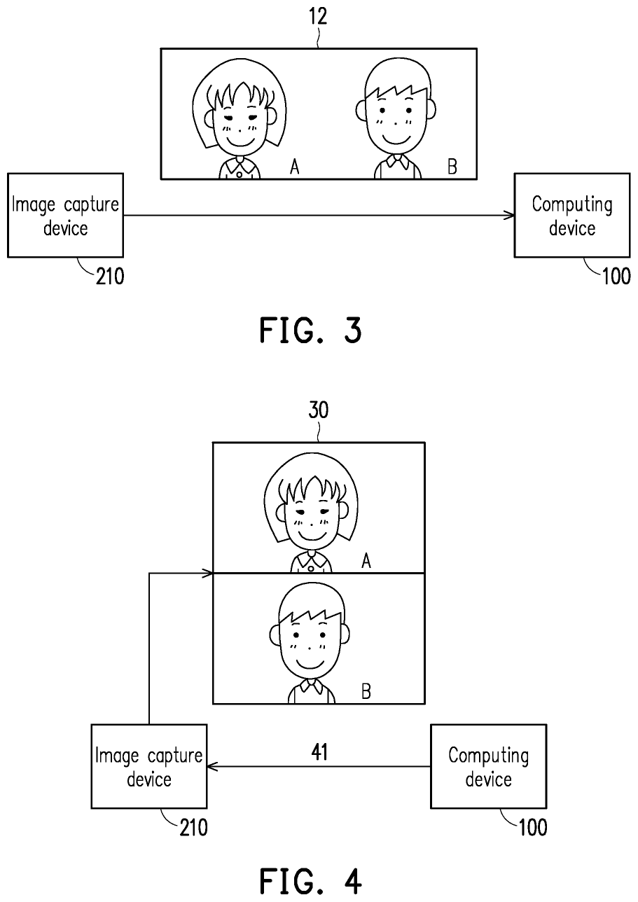

The image processing system 10 may map one or more regions of interest in the original image provided by a single image capture device to the layout of the output image, so as to generate the output image. FIG. 3 is a schematic diagram of an original image provided by a single image capture device according to an embodiment of the disclosure. After the image capture device 210 obtains the original image 11, the image capture device 210 may execute down-sampling on the original image 11 to generate the down-sampled image 12. The resolution of the down-sampled image 12 may be lower than the resolution of the original image 11. For example, if the resolution of the original image 11 is 3840×2160, the resolution of the down-sampled image 12 may be 1920×360.

The image capture device 210 may transmit the down-sampled image 12 to the computing device 100 for the computing device 100 to execute object detection. The computing device 100 may execute object detection using a machine learning model. Compared with transmitting the original image 11 to the computing device 100, transmitting the down-sampled image 12 to the computing device 100 may greatly reduce the cost of transmission resources. In one implementation, the image capture device 210 (or the image capture device 210) and the computing device 100 may communicate through wired signals or wireless signals. The wired signal includes, for example, a universal serial bus (USB) video class (UVC) extension unit of a USB, a human interface device (HID), or a windows compatible ID (WCID). The wireless signal includes, for example, a hypertext transfer protocol (HTTP) request or a WebSocket.

After obtaining the down-sampled image 12, the computing device 100 may generate information 41 corresponding to the original image 11 according to the down-sampled image 12. The information 41 may include one or more region of interest (ROI) descriptors respectively corresponding to one or more ROI. The computing device 100 may transmit the information 41 to the image capture device 210, and the image capture device 210 may generate an output image 30 according to the information 41, as shown in FIG. 4.

Table 1 is an example of a single ROI descriptor corresponding to the original image 11. The attribute “(src_x, src_y)” and the attribute “(src_w, src_h)” may represent the mapping relationship between the source image (i.e., the down-sampled image 12) and the ROI window. The attribute “(dst_x, dst_y)” and the attribute “(dst_w, dst_h)” may represent the mapping relationship between the ROI window and the target image (i.e., the output image 30 or the layout of the output image 30). The attribute “(dst_w, dst_h)” may be related to the resolution supported by the video conferencing software. The computing device 100 may determine the value of the attribute “(dst_w, dst_h)” according to the resolution supported by the video conferencing software.

TABLE 1

| Attribute | Description |
|---|---|
| win_id | Identifier of the ROI window in the source image |
| (src_x, src_y) | The origin (upper left point) coordinates of the ROI |
| | window in the source image |
| (src_w, src_h) | The width and height (resolution) of the ROI window |
| | in the source image |
| (dst_x, dst_y) | The origin (upper left point) coordinates of the display |
| | area in the target image |
| (dst_w, dst_h) | The width and height (resolution) of the display area |
| | in the target image |

Referring to Table 1, if the resolution of the original image 11 is the same as the resolution of the down-sampled image 12, the attribute “(src_x, src_y)” and the attribute “(src_w, src_h)” may represent the mapping relationship between the original image 11 and the ROI window. If the resolution of the original image 11 is different from the resolution of the down-sampled image 12, the image capture device 210 may update the values of the attribute “(src_x, src_y)” and the attribute “(src_w, src_h)” according to the resolution of the original image 11 and the resolution of the down-sampled image 12, so that the attribute “(src_x, src_y))” and the attribute “(src_w, src_h)” may represent the mapping relationship between the original image 11 and the ROI window. For example, it is assumed that the resolution of the down-sampled image 12 is 1920×464, the resolution of the original image 11 is 7200×1740, and the attribute “(src_x, src_y)” and the attribute “(src_w, src_h)” in the ROI descriptor represent the mapping relationship between the down-sampled image 12 and the ROI window. After the image capture device 210 obtains the ROI descriptor from the computing device 100, the image capture device 210 may update the value of the attribute “(src_w, src_h)” from (1920, 464) to (7200, 1740). Accordingly, the attribute “(src_x, src_y)” and the updated attribute “(src_w, src_h)” may represent the mapping relationship between the original image 11 and the ROI window.

In one embodiment, the mapping relationship between the ROI window and the target image (or source image) may be edited by the user through the layout configuration of the video conferencing software according to requirements. The computing device 100 may receive the user instruction including the layout configuration through the transceiver 130, and determine the values of the attribute “(dst_x, dst_y)” and the attribute “(dst_w, dst_h)” associated with the target image (or the attribute “(src_x, src_y)” and the attribute “(src_w, src_h)” associated with the source image) according to the layout configuration. In other words, the computing device 100 may generate the mapping relationship between the ROI window and the target image (or the source image) according to the user instruction.

In one embodiment, the computing device 100 may execute object detection on the down-sampled image 12 to generate an object detection result, and generate information 41 including the ROI descriptor according to the object detection result. Specifically, the computing device 100 may identify the person in the down-sampled image 12 to generate a bounding box corresponding to the person. The computing device 100 may set the values of the attribute “(src_x, src_y)” and the attribute “(src_w, src_h)” according to the bounding box so that the bounding box is included in the ROI window formed of the attribute “(src_x, src_y)” and the attribute “(src_w, src_h)”. In this way, it may ensure that the image of the person in the bounding box is displayed in the output image of the video conferencing software.

If the object detection result corresponding to the down-sampled image 12 includes multiple bounding boxes, the computing device 100 may determine at least one selected bounding box from the bounding boxes. The computing device 100 may generate the values of the attribute “(src_x, src_y)” and the attribute “(src_w, src_h)” representing the mapping relationship between the ROI window and the source image or generate the values of the attribute “(dst_x, dst_y)” and the attribute “(dst_w, dst_h)” representing the mapping relationship between the ROI window and the target image according to the selected bounding box, thereby generating the information 41 including the ROI descriptor.

In one embodiment, the computing device 100 may receive a user instruction through the transceiver 130, and determine a selected bounding box from multiple bounding boxes according to the user instruction. In other words, the selected bounding box may be determined by the user.

In one embodiment, the computing device 100 may obtain audio from the audio capture device (e.g., the audio capture device 310), and select a bounding box corresponding to the audio from multiple bounding boxes as the selected bounding box. The computing device 100 may generate the value of the attribute “(src_x, src_y)”, the attribute “(src_w, src_h)”, the attribute “(dst_x, dst_y)”, or the attribute “(dst_w, dst_h)” according to the selected bounding box, and then generate the information 41 including the ROI descriptor. For example, the computing device 100 may determine which of the bounding boxes the speaker in the video conference corresponds to according to the audio based on the machine learning algorithm. The computing device 100 may select the bounding box corresponding to the speaker as the selected bounding box. The computing device 100 may determine the value of the attribute “(src_x, src_y)”, the attribute “(src_w, src_h)”, the attribute “(dst_x, dst_y)”, or the attribute “(dst_w, dst_h)” according to the selected bounding box. The computing device 100 may capture the image including the speaker from the original image 11 according to the ROI window formed of the attribute “(src_x, src_y)” and the attribute “(src_w, src_h)”, and configure the image of the speaker at an important position (e.g., in the middle) of the output image according to the attribute “(dst_x, dst_y)” and the attribute “(dst_w, dst_h)”. Accordingly, the participants in the video conference may instantly confirm who the current speaker is.

In one embodiment, the computing device 100 may generate values of the attribute “(src_x, src_y)” and the attribute “(src_w, src_h)” representing the mapping relationship between the ROI window and the source image according to the bounding boxes corresponding to the down-sampled image 12, thereby generating the information 41 including the ROI descriptor. For example, if the number of bounding boxes of the object detection result is greater than the threshold, the computing device 100 may determine that the density of people in the down-sampled image 12 is high. Accordingly, the computing device 100 may determine the values of the attribute “(src_x, src_y)” and the attribute “(src_w, src_h)” according to the number of bounding boxes, so that the ROI window includes more people. If the number of bounding boxes of the object detection result is less than or equal to the threshold, the computing device 100 may determine that the density of people in the down-sampled image 12 is low. Accordingly, the computing device 100 may determine the values of the attribute “(src_x, src_y)” and the attribute “(src_w, src_h)” according to the number of bounding boxes, so that the ROI window includes fewer people. In other words, the value of the attribute “(src_w, src_h)” may increase as the number of bounding boxes increases and decrease as the number of bounding boxes decreases.

After the image capture device 210 obtains the information 41, the image capture device 210 may generate an output image according to the information 41, and transmit the output image to the video conferencing software. Specifically, the image capture device 210 may obtain the values of the attribute “(src_x, src_y)” and the attribute “(src_w, src_h)” representing the mapping relationship between the ROI window and the source image from the ROI descriptor of the information 41, and crop a cropped image including the ROI window from the original image 11 according to the mapping relationship. The image capture device 210 may obtain the attribute “(dst_x, dst_y)” and the attribute “(dst_w, dst_h)” representing the mapping relationship between the ROI window (or the cropped image) and the target image from the ROI descriptor of the information 41, so as to determine the position of the cropped image in the layout of the output image 30. Thereby, the output image 30 is generated and the output image 30 is transmitted to the video conferencing software. As shown in FIG. 4, the image capture device 210 may crop a cropped image including the person A and a cropped image including the person B from the original image 11. The image capture device 210 may configure the two cropped images in a layout to generate an output image 30.

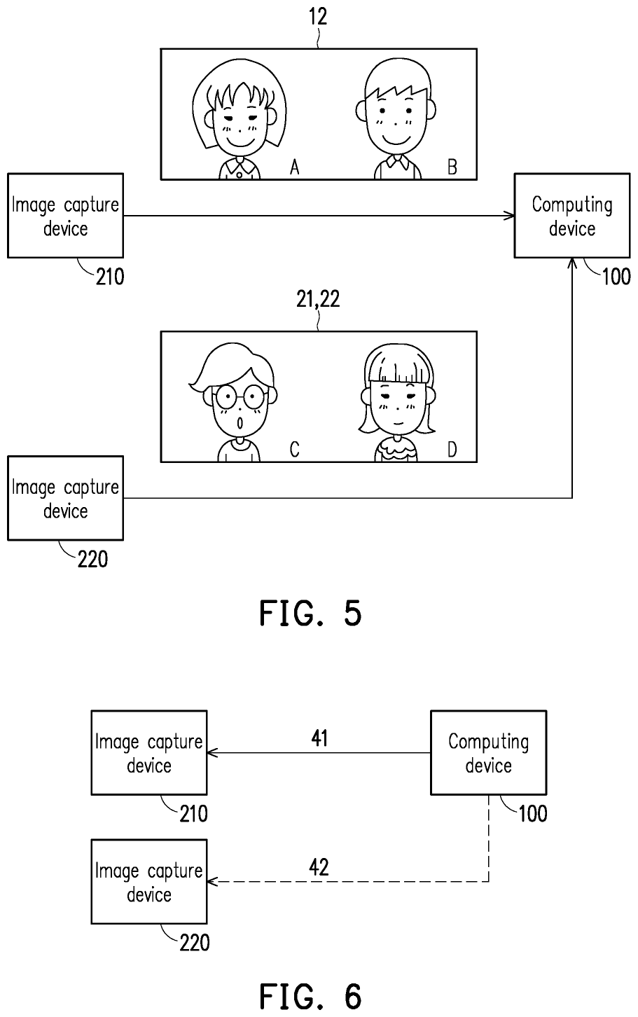

The image processing system 10 may obtain multiple original images respectively corresponding to multiple image capture devices from the image capture devices, and map one or more regions of interest in each of the original images to the layout of the output image, so as to generate the output image. FIG. 5 is a schematic diagram of an original image provided by multiple image capture devices according to an embodiment of the disclosure. After the image capture device 210 obtains the original image 11, the image capture device 210 may execute down-sampling on the original image 11 to generate the down-sampled image 12. The resolution of the down-sampled image 12 may be lower than the resolution of the original image 11. On the other hand, after the image capture device 220 obtains the original image 21, the image capture device 220 may selectively execute down-sampling on the original image 21 to generate the down-sampled image 22. The resolution of the down-sampled image 22 may be lower than the resolution of the original image 21.

The image capture device 210 may transmit the down-sampled image 12 to the computing device 100 for the computing device 100 to execute object detection. The image capture device 220 may transmit the original image 21 or the down-sampled image 22 to the computing device 100 for the computing device 100 to execute object detection.

After obtaining the down-sampled image 12, the computing device 100 may generate information 41 corresponding to the original image 11 according to the down-sampled image 12. The information 41 may include one or more ROI descriptors respectively corresponding to one or more ROI, as shown in Table 1. FIG. 6 is a schematic diagram of information provided by multiple image capture devices according to an embodiment of the disclosure. The computing device 100 may transmit the information 41 to the image capture device 210.

On the other hand, after obtaining the original image 21 or the down-sampled image 22, the computing device 100 may generate information 42 corresponding to the original image 21 according to the original image 21 or the down-sampled image 22. The information 42 may include one or more ROI descriptors respectively corresponding to one or more ROI. Table 2 is an example of a single ROI descriptor corresponding to the original image 21. The attribute “(src_x2, src_y2)” and the attribute “(src_w2, src_h2)” may represent the mapping relationship between the source image (i.e., the down-sampled image 22 or the original image 21) and the ROI window. If the image capture device 220 transmits the original image 21 to the computing device 100 in the process of FIG. 5, the attribute “(src_x2, src_y2)” and the attribute “(src_w2, src_h2)” may represent the mapping relationship between the original image 21 and the ROI window. If the image capture device 220 transmits the down-sampled image 22 to the computing device 100 in the process of FIG. 5, the attribute “(src_x2, src_y2)” and the attribute “(src_w2, src_h2)” may represent the mapping relationship between the down-sampled image 22 and the ROI window. The attribute “(dst_x2, dst_y2)” and the attribute “(dst_w2, dst_h2)” may represent the mapping relationship between the ROI window and the target image (i.e., the output image 30 or the layout of the output image 30). The attribute “(dst_w2, dst_h2)” may be related to the resolution supported by the video conferencing software. The computing device 100 may determine the value of the attribute “(dst_w2, dst_h2)” according to the resolution supported by the video conferencing software.

TABLE 2

| Attribute | Description |
|---|---|
| win_id2 | Identifier of the ROI window in the source image |
| (src_x2, src_y2) | The origin (upper left point) coordinates of the ROI |
| | window in the source image |
| (src_w2, src_h2) | The width and height (resolution) of the ROI window |
| | in the source image |
| (dst_x2, dst_y2) | The origin (upper left point) coordinates of the display |
| | area in the target image |
| (dst_w2, dst_h2) | The width and height (resolution) of the display area |
| | in the target image |

Referring to Table 2, it is assumed that the image capture device 220 transmits the down-sampled image 22 to the computing device 100 in the process of FIG. 5, and the source image in the ROI descriptor is the down-sampled image 22. If the resolution of the original image 21 is the same as the resolution of the down-sampled image 22, the attribute “(src_x2, src_y2)” and the attribute “(src_w2, src_h2)” may represent the mapping relationship between the original image 21 and the ROI window. If the resolution of the original image 21 is different from the resolution of the down-sampled image 22, the image capture device 210 may update the values of the attribute “(src_x2, src_y2)” and the attribute “(src_w2, src_h2)” according to the resolution of the original image 21 and the resolution of the down-sampled image 22, so that the attribute “(src_x2, src_y2)” and the attribute “(src_w2, src_h2)” may represent the mapping relationship between the original image 21 and the ROI window.

In one embodiment, the mapping relationship between the ROI window and the target image (or source image) may be edited by the user through the layout configuration of the video conferencing software according to requirements. The computing device 100 may receive a user instruction including layout configuration through the transceiver 130. The computing device 100 may determine the values of the attribute “(dst_x, dst_y)” and the attribute “(dst_w, dst_h)” associated with the target image (or the attribute “(src_x, src_y)” and the attribute “(src_w, src_h)” associated with the source image) according to the layout configuration, and determine the values of the attribute “(dst_x2, dst_y2)” and the attribute “(dst_w2, dst_h2)” associated with the target image (or the attribute “(src_x2, src_y2)” and the attribute “(src_w2, src_h2)” associated with the source image) according to the layout configuration.

In one embodiment, the computing device 100 may execute object detection on the down-sampled image 12 to generate an object detection result, and generate information 41 including the ROI descriptor according to the object detection result. In addition, the computing device 100 may execute object detection on the original image 21 or the down-sampled image 22 to generate an object detection result, and generate information 42 including the ROI descriptor according to the object detection result. Specifically, the computing device 100 may identify the person in the down-sampled image 12 to generate a bounding box corresponding to the person. The computing device 100 may set the values of the attribute “(src_x, src_y)” and the attribute “(src_w, src_h)” according to the bounding box so that the bounding box is included in the ROI window formed of the attribute “(src_x, src_y)” and the attribute “(src_w, src_h)”. On the other hand, the computing device 100 may identify the person in the original image 21 or the down-sampled image 22 to generate a bounding box corresponding to the person. The computing device 100 may set the values of the attribute “(src_x2, src_y2)” and the attribute “(src_w2, src_h2)” according to the bounding box so that the bounding box is included in the ROI window formed of the attribute “(src_x2, src_y2)” and the attribute “(src_w2, src_h2)”.

If the object detection result corresponding to the down-sampled image 12 includes multiple bounding boxes, the computing device 100 may determine at least one selected bounding box from the bounding boxes. The computing device 100 may generate the values of the attribute “(src_x, src_y)” and the attribute “(src_w, src_h)” representing the mapping relationship between the ROI window and the source image or generate the values of the attribute “(dst_x, dst_y)” and the attribute “(dst_w, dst_h)” representing the mapping relationship between the ROI window and the target image according to the selected bounding box, thereby generating the information 41 including the ROI descriptor. On the other hand, if the object detection result corresponding to the original image 21 or the down-sampled image 22 includes multiple bounding boxes, the computing device 100 may determine at least one selected bounding box from the bounding boxes. The computing device 100 may generate the values of the attribute “(src_x2, src_y2)” and the attribute “(src_w2, src_h2)” representing the mapping relationship between the ROI window and the source image or generate the values of the attribute “(dst_x2, dst_y2)” and the attribute “(dst_w2, dst_h2)” representing the mapping relationship between the ROI window and the target image according to the selected bounding box, thereby generating the information 42 including the ROI descriptor.

In one embodiment, the computing device 100 may receive a user instruction through the transceiver 130, and determine a selected bounding box from multiple bounding boxes in the down-sampled image 12 according to the user instruction. On the other hand, the computing device 100 may determine a selected bounding box from multiple bounding boxes in the original image 21 or the down-sampled image 22 according to the user instruction.

In one embodiment, the computing device 100 may obtain audio from the audio capture device (e.g., the audio capture device 310) corresponding to the image capture device 210, and select a bounding box corresponding to the audio from multiple bounding boxes as the selected bounding box. The computing device 100 may generate the value of the attribute “(src_x, src_y)”, the attribute “(src_w, src_h)”, the attribute “(dst_x, dst_y)”, or the attribute “(dst_w, dst_h)” according to the selected bounding box, and then generate the information 41 including the ROI descriptor. On the other hand, the computing device 100 may obtain audio from the audio capture device (e.g., the audio capture device 320) corresponding to the image capture device 220, and select a bounding box corresponding to the audio from multiple bounding boxes as the selected bounding box. The computing device 100 may generate the value of the attribute “(src_x2, src_y2)”, the attribute “(src_w2, src_h2)”, the attribute “(dst_x2, dst_y2)”, or the attribute “(dst_w2, dst_h2)” according to the selected bounding box, and then generate the information 42 including the ROI descriptor.

In one embodiment, the computing device 100 may generate values of the attribute “(src_x, src_y)” and the attribute “(src_w, src_h)” representing the mapping relationship between the ROI window and the source image (i.e., the source image 11 or the down-sampled image 12) according to the bounding boxes corresponding to the image capture device 210, thereby generating the information 41 including the ROI descriptor. On the other hand, the computing device 100 may generate values of the attribute “(src_x2, src_y2)” and the attribute “(src_w2, src_h2)” representing the mapping relationship between the ROI window and the source image (the source image 21 or the down-sampled image 22) according to the bounding boxes corresponding to the image capture device 220, thereby generating the information 42 including the ROI descriptor. For example, if the number of bounding boxes of the object detection result of the source image 21 or the down-sampled image 22 is greater than the threshold, the computing device 100 may determine that the density of people in the down-sampled image 12 is high. Accordingly, the computing device 100 may determine the values of the attribute “(src_x2, src_y2)” and the attribute “(src_w2, src_h2)” according to the number of bounding boxes, so that the ROI window includes more people. If the number of bounding boxes of the object detection result is less than or equal to the threshold, the computing device 100 may determine that the density of people in the down-sampled image 12 is low. Accordingly, the computing device 100 may determine the values of the attribute “(src_x2, src_y2)” and the attribute “(src_w2, src_h2)” according to the number of bounding boxes, so that the ROI window includes fewer people.

The computing device 100 may determine the selected bounding box according to the object detection result corresponding to the image capture device 210 and the object detection result corresponding to the image capture device 220, and then generate the information 41 or the information 42 including the ROI descriptor according to the selected bounding box. It is assumed that the first object detection result corresponding to the image capture device 210 and the second object detection result corresponding to the image capture device 220 respectively include a first bounding box and a second bounding box corresponding to the same object, that is, the image capture device 210 and the image capture device 220 detect the same object. In one embodiment, the computing device 100 may select a selected bounding box representing the object from the first bounding box and the second bounding box. In response to the size of the first bounding box (i.e., the attribute “(src_w, src_h)”) being greater than the size of the second bounding box (i.e., the attribute “(src_w2, src_h2)”), the computing device 100 may select the first bounding box from the first bounding box and the second bounding box as the selected bounding box. In another embodiment, the computing device 100 may determine a first angle between the facing direction of the object and the image capture device 210 according to the first bounding box, and determine a second angle between the facing direction of the object and the image capture device 220 according to the second bounding box. In response to the first angle being less than the second angle, the computing device 100 may select the first bounding box from the first bounding box and the second bounding box as the selected bounding box.

Based on the above, if the same person is detected by multiple image capture devices and multiple bounding boxes are generated, the computing device 100 may determine the selected bounding box such that the person appears larger in the output image of the video conferencing software, or that the person in the output image faces the camera.

The computing device 100 may selectively transmit the information 42 to the image capture device 220. Referring to FIG. 5 and FIG. 6, if the image capture device 220 transmits the down-sampled image 22 to the computing device 100 in the process of FIG. 5, the computing device 100 may transmit the information 42 to the image capture device 220 in the process of FIG. 6. In contrast, if the image capture device 220 transmits the original image 21 to the computing device 100 in the process of FIG. 5, the computing device 100 may not transmit the information 42 to the image capture device 220 in the process of FIG. 6.

If the computing device 100 transmits the information 42 to the image capture device 220, the image capture device 220 may crop a corresponding cropped image from the original image 21 according to the information 4. If the computing device 100 does not transmit the information 42 to the image capture device 220, the computing device 100 may crop a corresponding cropped image from the original image 21 according to the information 42.

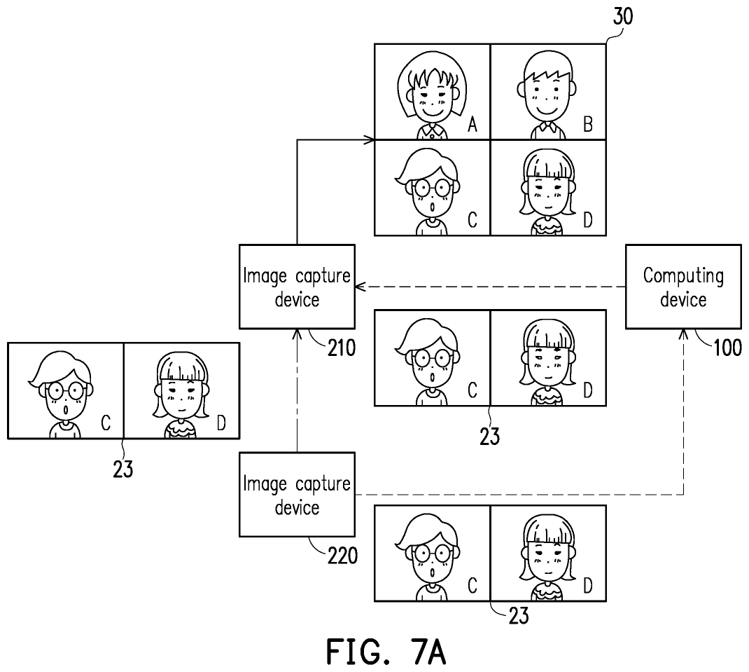

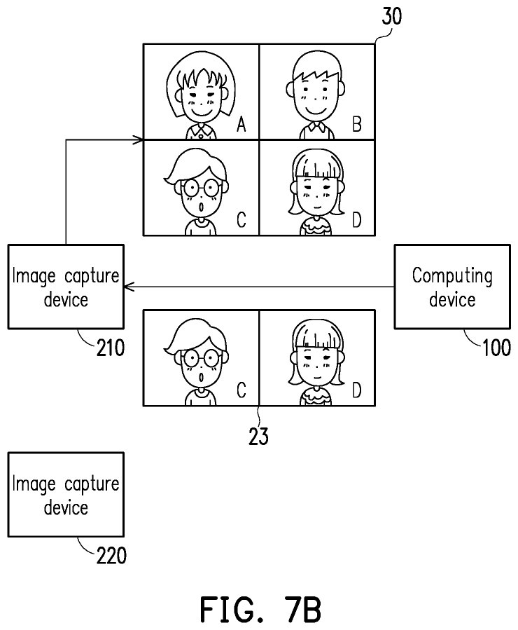

FIG. 7A is a schematic diagram of a cropped image 23 generated by an image capture device 220 according to an embodiment of the disclosure. The image capture device 220 may obtain the values of the attribute “(src_x2, src_y2)” and the attribute “(src_w2, src_h2)” representing the mapping relationship between the ROI window and the source image from the ROI descriptor of the information 42, and crop a cropped image 23 including the ROI window from the original image 21 according to the mapping relationship. The image capture device 220 may obtain the attribute “(dst_x2, dst_y2)” and the attribute “(dst_w2, dst_h2)” representing the mapping relationship between the ROI window (or the cropped image 23) and the target image from the ROI descriptor of the information 42, so as to determine the position of the cropped image 23 in the layout of the output image. The image capture device 220 may transmit data such as the cropped image 23, the attribute “(dst_x2, dst_y2)”, and the attribute “(dst_w2, dst_h2)” to the image capture device 210. In one embodiment, the image capture device 220 may be communicatively connected to the image capture device 210 to establish a connection, and directly transmit data to the image capture device 210 through the connection. In one embodiment, the image capture device 220 may transmit the data to the computing device 100 so that the computing device 100 forwards the data to the image capture device 210.

FIG. 7B is a schematic diagram of a cropped image 23 generated by a computing device 100 according to an embodiment of the disclosure. The computing device 100 may obtain the values of the attribute “(src_x2, src_y2)” and the attribute “(src_w2, src_h2)” representing the mapping relationship between the ROI window and the source image from the ROI descriptor of the information 42, and crop a cropped image 23 including the ROI window from the original image 21 according to the mapping relationship. The computing device 100 may obtain the attribute “(dst_x2, dst_y2)” and the attribute “(dst_w2, dst_h2)” representing the mapping relationship between the ROI window (or the cropped image 23) and the target image from the ROI descriptor of the information 42, so as to determine the position of the cropped image 23 in the layout of the output image. The computing device 100 may transmit data such as the cropped image 23, the attribute “(dst_x2, dst_y2)”, and the attribute “(dst_w2, dst_h2)” to the image capture device 210.

After the image capture device 210 obtains data such as the information 41, the cropped image 23, the attribute “(dst_x2, dst_y2)”, and the attribute “(dst_w2, dst_h2)”, the image capture device 210 may generate an output image according to the data, and transmit the output image to the video conferencing software. Specifically, the image capture device 210 may obtain the values of the attribute “(src_x, src_y)” and the attribute “(src_w, src_h)” representing the mapping relationship between the ROI window and the source image from the ROI descriptor of the information 41, and crop a cropped image including the ROI window from the original image 11 according to the mapping relationship. The cropped image includes, for example, person A and person B. The image capture device 210 may obtain the attribute “(dst_x, dst_y)” and the attribute “(dst_w, dst_h)” representing the mapping relationship between the ROI window (or the cropped image) and the target image from the ROI descriptor of the information 41, so as to determine the position of the cropped image in the layout of the output image 30.

On the other hand, the image capture device 210 may determine the position of the cropped image 23 in the layout of the output image 30 according to the attribute “(dst_x2, dst_y2)” and the attribute “(dst_w2, dst_h2)” representing the mapping relationship between the ROI window (or the cropped image 23) and the target image. The cropped image 23 includes, for example, person C and person D.

After the image capture device 210 determines the position of the cropped image corresponding to the original image 11 in the output image 30 and determines the position of the cropped image 23 corresponding to the original image 21 in the output image 30, the image capture device 210 generates an output image 30 including the above two cropped images, as shown in FIG. 7A or FIG. 7B. The image capture device 210 may transmit the output image 30 to the video conferencing software for use by the video conferencing software.

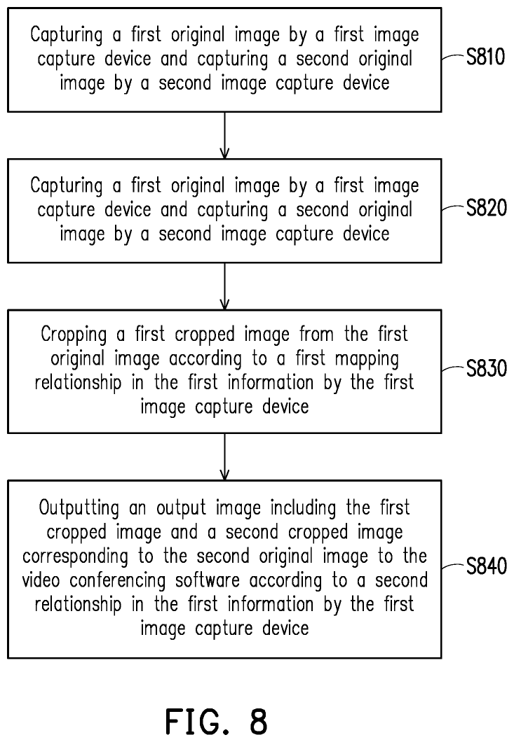

FIG. 8 is a flowchart of an image processing method for a video conferencing software according to an embodiment of the disclosure, in which the image processing method may be implemented by the image processing system 10 shown in FIG. 1. In step S810, a first original image is captured by the first image capture device, and a second original image is captured by the second image capture device. In step S820, first information corresponding to the first original image is generated, and the first information is transmitted to the first image capture device. In step S830, a first cropped image is cropped from the first original image according to a first mapping relationship in the first information by the first image capture device. In step S840, an output image including the first cropped image and a second cropped image corresponding to the second original image are output to the video conferencing software according to a second mapping relationship in the first information by the first image capture device.

To sum up, the image processing system of the disclosure may execute down-sampling on the original image. The image processing system may determine the mapping relationship related to the ROI according to the down-sampled image, so as to reduce the cost of computing resources and transmission resources. The image capture device may capture the cropped image from the original image according to the mapping relationship, and map the cropped image to a specific position of the layout to generate an output image of the video conferencing software. In addition, the image processing system may also dynamically adjust the region of interest based on information such as audio source, bounding box size, user facing direction, or user instruction, so that the output image may instantly display the most important person in the current video conference.

What is claimed is:

1. An image processing system for a video conferencing software, comprising:
a first image capture device, capturing a first original image;
a second image capture device, capturing a second original image; and
a computing device, communicatively connected to the first image capture device and the second image capture device and generating first information corresponding to the first original image, wherein
the first image capture device obtains the first information, and crops a first cropped image from the first original image according to a first mapping relationship in the first information, wherein
the first image capture device outputs an output image comprising the first cropped image and a second cropped image corresponding to the second original image to the video conferencing software according to a second mapping relationship in the first information.

2. The image processing system according to claim 1, wherein
the first image capture device generates a first down-sampled image according to the first original image, and transmits the first down-sampled image to the computing device, wherein
the computing device generates the first information according to the first down-sampled image, wherein resolution of the first down-sampled image is less than resolution of the first original image.

3. The image processing system according to claim 1, wherein
the computing device generates second information corresponding to the second original image, and transmits the second information to the second image capture device, wherein
the second image capture device crops the second cropped image from the second original image according to a third mapping relationship in the second information.

4. The image processing system according to claim 3, wherein
the second image capture device generates a second down-sampled image according to the second original image, and transmits the second down-sampled image to the computing device, wherein
the computing device generates the second information according to the second down-sampled image, wherein resolution of the second down-sampled image is less than resolution of the second original image.

5. The image processing system according to claim 3, wherein
the second image capture device is communicatively connected to the first image capture device, and transmits the second cropped image to the first image capture device.

6. The image processing system according to claim 3, wherein
the second image capture device transmits the second cropped image to the first image capture device through the computing device.

7. The image processing system according to claim 1, wherein
the computing device obtains the second original image from the second image capture device, generates the second cropped image according to the second original image, and transmits the second cropped image to the first image capture device.

8. The image processing system according to claim 1, wherein the second mapping relationship comprises a mapping relationship between the first cropped image and the output image and a mapping relationship between the second cropped image and the output image.

9. The image processing system according to claim 2, wherein
the computing device executes object detection on the first down-sampled image to generate a first object detection result, and generates the first information according to the first object detection result.

10. The image processing system according to claim 9, wherein the first object detection result comprises a plurality of bounding boxes, wherein the image processing system further comprises:
an audio capture device, communicatively connected to the computing device, wherein
in response to obtaining audio from the audio capture device, the computing device selects a first bounding box corresponding to the audio from the bounding boxes, and generates the first information according to the first bounding box.

11. The image processing system according to claim 9, wherein
the computing device obtains the first object detection result corresponding to the first image capture device and a second object detection result corresponding to the second image capture device, wherein the first object detection result comprises a first bounding box corresponding to an object, and the second object detection result comprises a second bounding box corresponding to the object, wherein
in response to a size of the first bounding box being greater than a size of the second bounding box, the computing device selects the first bounding box from the first bounding box and the second bounding box to generate the first information according to the first bounding box.

12. The image processing system according to claim 9, wherein
the computing device obtains the first object detection result corresponding to the first image capture device and a second object detection result corresponding to the second image capture device, wherein the first object detection result comprises a first bounding box corresponding to an object, and the second object detection result comprises a second bounding box corresponding to the object, wherein
the computing device determines a first angle between a facing direction of the object and the first image capture device according to the first bounding box, and determines a second angle between the facing direction of the object and the second image capture device according to the second bounding box, wherein
in response to the first angle being less than the second angle, the computing device selects the first bounding box from the first bounding box and the second bounding box to generate the first information according to the first bounding box.

13. The image processing system according to claim 1, wherein
the computing device receives a user instruction, and generates the first mapping relationship according to the user instruction.

14. The image processing system according to claim 9, wherein the first object detection result comprises a plurality of bounding boxes, wherein
the computing device receives a user instruction, and selects a first bounding box from the bounding boxes according to the user instruction to generate the first mapping relationship according to the first bounding box.

15. The image processing system according to claim 9, wherein the first object detection result comprises a plurality of bounding boxes, wherein
the computing device generates the first mapping relationship according to a number of the bounding boxes.

16. The image processing system according to claim 1, wherein the first mapping relationship comprises a first size and a first coordinate corresponding to the first original image, wherein the second mapping relationship comprises a second size and a second coordinate corresponding to the output image.

17. The image processing system according to claim 2, wherein the first mapping relationship comprises a first size corresponding to the first down-sampled image, wherein
the first image capture device updates the first size according to the resolution of the first original image and the resolution of the first down-sampled image.

18. An image processing method for a video conferencing software, comprising:
capturing a first original image by a first image capture device and capturing a second original image by a second image capture device;
generating first information corresponding to the first original image and transmitting the first information to the first image capture device;
cropping a first cropped image from the first original image according to a first mapping relationship in the first information by the first image capture device; and
outputting an output image comprising the first cropped image and a second cropped image corresponding to the second original image to the video conferencing software according to a second mapping relationship in the first information by the first image capture device.
